(19) United States
(12) Patent Application Publication
(10) Pub. No.: US 2015/0201165 A1
(43) Pub. Date: Jul. 16, 2015

(54) SURVEILLANCE OF A RAILWAY TRACK

(71) Applicant: SIEMENS AKTIENGESELLSCHAFT, MUENCHEN (DE)

(72) Inventors: Siegfried Bocionek, Berlin (DE); Marc Burkhardt, Braunschweig (DE); Wilfried Matthee, Salzgitter (DE)

(21) Appl. No.: 14/424,510

(22) PCT Filed: Aug. 26, 2013
(86) PCT No.: PCT/EP2013/067625

§ 371 Date: Feb. 27, 2015

(30) Foreign Application Priority Data
Aug. 31, 2012 (DE) 102012215544.9

(51) Int. Cl. H04N 7/18; B61L 23/04

(52) U.S. Cl. CPC H04N 7/181; B61L 23/04

(57) ABSTRACT

A method for surveillance of a railroad track includes equipping rail vehicles which run on the railroad track with a recording unit which takes images of the railroad track or the surroundings thereof. The images are saved and automatically processed or analyzed for specific incidents by using image detection procedures. If such an incident is detected, an action can be executed, an alarm triggered or a police investigation initiated. At the same time, it is advantageous that a flexible surveillance of the railroad track and effective procedures to prevent theft and damage along the railroad track can be achieved by using inexpensive resources. The images can also be transmitted to a central location and monitored there (e.g. continuously) by operators. A rail vehicle, an apparatus for surveillance of a railroad track and a system having a rail vehicle and a central unit are also provided.

The invention relates to a method and apparatus for surveillance of a railroad track. A corresponding rail vehicle and a system for surveillance of the railroad track are also proposed.

Significant damage and travel disruption result from vandalism to facilities along the railroad track and the theft of cables and other components.

It is disadvantageous in this respect that systematic or even total or extensive surveillance is complex and expensive.

It is the object of the invention to avoid the disadvantages mentioned above and in particular to specify an efficient approach to the surveillance of facilities or components along a railroad track.

This object is achieved according to the features of the independent claims. Preferred embodiments will emerge in particular from the dependent claims.

To achieve the object a method for surveillance of a railroad track is specified
wherein at least one recording of the railroad track or along the railroad track is taken by means of a recording unit,
wherein the recording unit is arranged in or on a rail vehicle,
wherein the at least one recording is stored in the rail vehicle and/or in a central unit.

Thus (partially or totally) continuous observation of the railroad track and/or the (direct) surroundings of the railroad track can be performed for example on frequently traveled tracks. The acquired data can be stored locally in the rail vehicle and/or can be transmitted to a central unit and stored there. In particular it is possible for different quality levels of the recording to be stored in the rail vehicle and be transmitted to the central unit.

The central unit is for example a computer or a computer network (which can also be arranged in a distributed manner). The central unit can be operated by an operator of the rail network or by a service provider.

It is advantageous there that a manual or automatic analysis of the transmitted or stored recordings can take place based on the surveillance provided, for example in order to carry out a predefined action or to preserve evidence.

The manual analysis can be performed by different operators at surveillance monitors of the central unit.

In addition to a manual or automatic analysis partially automatic analysis is also possible, with significant image content being recognized automatically in the images in a first analysis based on defined features or feature vectors automatically obtained from the images. A comparison with features or feature vectors of previously recorded images can also be used here to identify particularities. This first analysis allows image preselection and in a subsequent step a manual analysis can be performed on the significantly reduced image material.

In one development the at least one recording is analyzed for a predefined incident.

One embodiment consists of analyzing the at least one recording shortly after storing or after the incident has been detected.

For example the recording can be archived and only analyzed in the event of suspicion, for example in the context of a police investigation.

In another development a predefined action is performed when the predefined incident is identified.

In one development in particular the predefined action comprises at least one of the following options:
an assessment of a recording or scene by personnel observing surveillance monitors,
identification of people involved in the incident, in particular by means of facial recognition, or license plate recognition of vehicles involved,
making an emergency call, in particular informing the police, a security service and/or an emergency service,
initiating a police investigation,
forwarding the at least one recording for further analysis,
forwarding the at least one recording, in particular with a higher quality level than before, to the central unit.

In another development the incident comprises one of the following options
a theft,
an act of damage,
an accident,
an emergency incident.

Deviations from a “normal” state can in particular be identified automatically based on image processing algorithms. Such a deviation can trigger a predefined action directly.

In a further development the at least one recording is stored with time information and/or position information.

The position information and/or time information can be used to determine the location of an incident. This location information is advantageous for the initiation of the predefined action.

In the context of an additional development a plurality of recording units are arranged in or on the rail vehicle.

It is advantageous here that regions along the railroad track can be recorded by the number of recording units. For example the recording units can be embodied to be at least partially movable, so that during recording as the rail vehicle travels they can be moved at a predefined speed in such a manner that a predefined region can be recorded as effectively as possible. For example a camera with a wide-angle lens can be moved counter to the travel direction of the rail vehicle in order to be able to record a region for as long as possible. The recording units can be activated by way of the rail vehicle (or a computer or a control unit of the rail vehicle) and/or by way of the central unit.

In a next development the recording unit is arranged on the front, the rear or on a side of the rail vehicle.

In particular a plurality of recording units can be arranged on the rail vehicle, even at different locations on (along) the rail vehicle. It is therefore also possible for a number of recording units to supply an image sequence, which is edited or processed accordingly.

In one embodiment the recording unit comprises at least one of the following components:
a photographic camera,
a film camera,
an infrared camera,
a depth imaging camera,
a microphone,
a radar device,
a sensor for determining a relative traveled distance.

In particular the recording unit can be embodied to be sensitive at defined wavelengths. Thus usable recordings can be taken specifically at night or in the dark, for example in tunnels. An illumination unit can also be provided, which lights up a landmark along the railroad track with light in a predefined wavelength range so that a recording can be taken by a recording unit that is sensitive in said wavelength range.

In an alternative embodiment the recording comprises an image recording, in particular individual images or moving images and/or a sound recording.

In an alternative embodiment the recording unit has a wide-angle lens, in particular a fish-eye.

In a next embodiment the at least one recording is transformed.

The transformation allows distorted recordings, for example due to the optical system of a lens and/or the sped of the train, to be compensated for at least partially, thus providing an essentially undistorted image.

In another embodiment the at least one recording is transmitted from the rail vehicle to the central unit by means of a wireless or wired interface and/or by means of a storage medium.

In one development the at least one recording is stored by means of a progressive compression algorithm in the rail vehicle and the different quality levels of the progressively encoded recording are provided for transmission to the central unit.

A progressive compression algorithm encodes images or image sequences (videos) for example at different levels, the level being higher, the higher the bit rate or resolution. A base level ensures a minimum quality of the images or image sequences, the higher levels improve this minimum quality incrementally, for example up to full recording resolution. It is therefore possible to transmit images or videos to the central unit at a base level with a low bit rate and (initially) only to store for example the data with the highest level locally. If necessary then data with a higher level can be supplied to the central unit for a scene of interest. The computation outlay for automated processing of the data (within the context of image recognition for example) is also simplified and can therefore be performed more quickly (if required therefore in real time or almost in real time), if the recordings only have a low resolution. If automated processing shows a potential incident, the recording in question can be analyzed again at a higher resolution. This means that the computation outlay for automated processing, whether locally at the rail vehicle or on the part of the central unit, can be significantly reduced. For example the encoding methods (compression methods) used can be JPEG 2000, MPEG-4, H.264.

In an additional embodiment the at least one recording can be analyzed for the predefined incident by comparing the recording with previously stored data.

Different methods or algorithms for image processing or image recognition can be used in the context of such a comparison. For example a comparison can be performed between parts of an image (in relation to individual image recordings or in image sequences (videos)) to find a measure of how similar one recording is to a previously taken recording. Such a measure of similarity (e.g. a distance between feature vectors) can be compared with a threshold value to determine whether there is sufficient similarity between an image, image sequence or subject and previously stored data.

The previously stored data can be training data and/or further data, for example work schedules of maintenance crews. This further data can be supplied in an automated manner and can therefore be taken into account during the analysis. As there is generally precise regulation beforehand concerning where and when a maintenance crew is active along the railroad track, it is possible in an automated manner to prevent the purely visual deviation produced by the maintenance crew being identified as an incident requiring the triggering of an alarm.

In another embodiment the incident is identified if the at least one recording deviates from the previously stored data.

In an alternative embodiment the incident is identified if the at least one recording does not deviate from the previously stored data.

For example it can thus be identified in an automated manner if the previously stored data does not yet contain for example a facility or component which has been set up in the meantime. The current recording should therefore “normally” deviate from the previously stored data. Another example is the known deployment of a maintenance crew along a track segment. If there is no deviation from the previously stored data (without maintenance crew) in this track segment, there may be an error, for example the maintenance crew is not in the right track segment, the work schedules are incorrect, the maintenance crew is late, etc.

It is also possible for the previously stored data to be generated by means of at least one training run.

The training run can be performed specifically for the acquisition of the track segments and for storing parts of the track segments or facilities or components along the railroad track. The training run can also be part of a scheduled journey of a rail vehicle; in particular the previously stored data can be updated, adapted or checked in this manner.

In a further embodiment
recordings are taken during the training run and
the recordings are edited and stored.

In another development a plurality of training runs are performed and the previously stored data is averaged and/or adapted by means of the training runs.

In one development the recordings are edited in that at least one feature vector is determined for predefined components or facilities along the railroad track and the at least one feature vector is stored.

In another development a plurality of training runs are performed and the previously stored data is averaged and/or adapted by means of the training runs.

In particular it is possible for a “normal” journey also to be used at least in part as a training run in that for example the feature vector determined from the recording is used to average or adapt the stored data.

In particular the previously stored data can comprise a number of recordings of surroundings. For example such surroundings can be acquired in different weather conditions or with different variations that can be classed as “normal” (e.g. grazing cattle).

In another embodiment the recording unit is prompted by the central unit to take a recording of the railroad track or along the railroad track in defined positions.

For example the recording unit can be prompted by the central unit, optionally by way of a computer that activates the recording unit, to supply recordings of a defined track segment. To this end the recording unit can optionally be controlled by the central unit in respect of its position or alignment (if the recording unit is embodied as movable) as well as in respect of resolution, image quality, aperture, etc. One reason for this may be that a previous rail vehicle has supplied recordings of a track segment that require further clarification. The central unit can then prompt a subsequent rail vehicle on this track segment to take recordings specifically of the surroundings of interest.

It is therefore also possible for the central unit to control the recording units of different rail vehicles, which travel along the same railroad track for example one after the other, in such a manner that there is the most favorable or extensive surveillance possible of the railroad track.

The above embodiments apply to the rail vehicle outlined below as well as the apparatus (central unit), the system and the further claim categories correspondingly.

The abovementioned object is also achieved by a rail vehicle
with at least one recording unit, which is arranged in or on the rail vehicle,
with at least one processing unit which is set up in such a manner that
at least one recording of the railroad track or along the railroad track can be taken by means of the recording unit,
the at least one recording can be stored in the rail vehicle and/or in a central unit.

The abovementioned object is also achieved by means of an apparatus for surveillance of a railroad track, with at least one processing unit which is set up in such a manner that
at least one recording of the railroad track or along the railroad track can be received from a rail vehicle, which is provided with a recording unit in or on the rail vehicle, by means of the recording unit,
the at least one recording can be stored.

In one development the apparatus is provided with at least one surveillance monitor, on which the at least one recording received from the rail vehicle can be shown, it being possible for the at least one surveillance monitor to be used for continuous surveillance by personnel.

The object is also achieved based on a system comprising at least one rail vehicle and an apparatus (central unit),
wherein the rail vehicle transmits recordings of a predefined quality level to the central unit,
wherein a predefined action is performed by the central unit in the event of a predefined incident based on the recordings and an analysis relating to the predefined incident.

The solution proposed here also comprises a computer program product which can be loaded directly into a storage unit of a digital computer, comprising program code parts which are suitable for performing steps of the method described here.

The abovementioned problem is also resolved by means of a computer-readable storage medium, for example any storage unit, comprising instructions that can be executed by a computer (e.g. in the form of program code) and are suitable to allow the computer to perform steps of the method described here.

The properties, features and advantages of this invention as described above as well as the manner in which these are achieved will become clearer and more readily understandable in conjunction with the schematic description of exemplary embodiments which follows, said exemplary embodiments being described in more detail in conjunction with the drawings. Identical elements or those with the same effect can be provided with identical reference characters for the sake of clarity here. In the drawings:

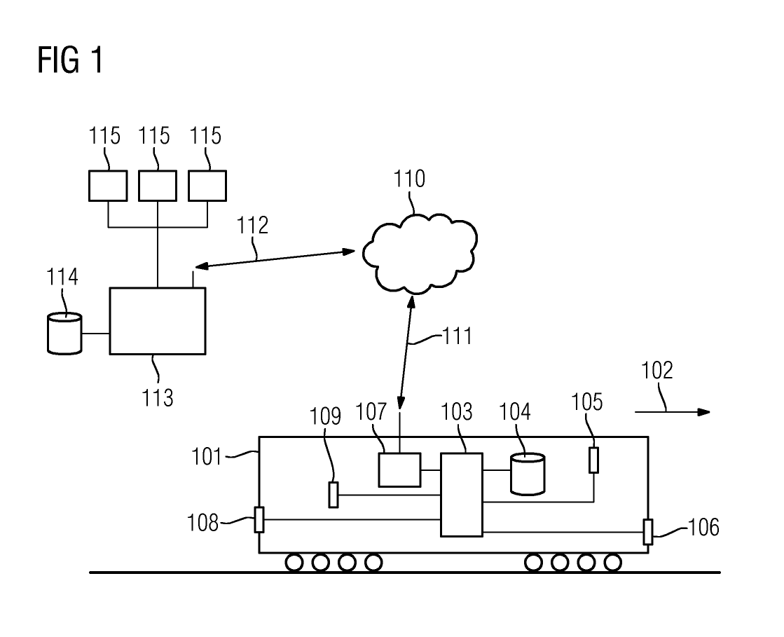

FIG. 1 shows an exemplary scenario for surveillance of a railroad track with a rail vehicle;

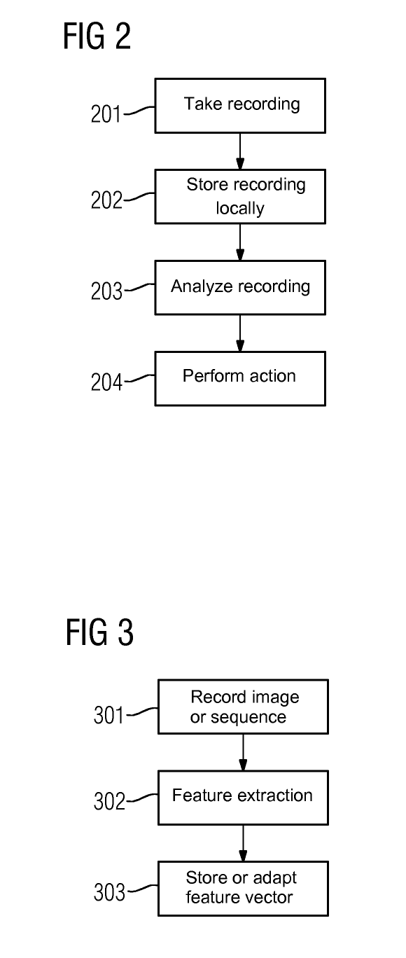

FIG. 2 shows an exemplary schematic flow diagram showing steps of the method set out here for surveillance of a railroad track;

FIG. 3 shows an exemplary schematic flow diagram of a training session, as performed for example in the context of a training run of a rail vehicle to create training data, in particular feature vectors.

According to the solution set out here it is proposed that a rail vehicle is equipped with at least one recording device, for example a video camera or photographic camera. The recording device is used to record the railroad track or track surroundings (e.g. a region along the railroad track) of the rail vehicle is recorded with the recording device.

Such recordings can be used to detect for example whether there is damage or theft of materials or components along the railroad track. If such an incident is identified, countermeasures can also be initiated automatically as required. It is also an option to analyze recorded incidents and try to determine the guilty parties at a later stage.

The recording device can be a video camera. A wide-angle lens (e.g. a so-called fish-eye with an angle of view of approx. 180 degrees) for example can be provided. Such a recording device can be positioned for example on the front and/or side of the rail vehicle.

Distorted image recordings can be rectified electronically as required, for example by means of a suitable transformation (where necessary as appropriate for the respective camera lens) to an undistorted (or only slightly distorted) (wide-screen) format.

One option is for the recording device to record in the infrared range. A thermal imaging camera for example can be positioned on the rail vehicle for this purpose. This has the advantage that incidents along the railroad track can be recorded both at night and also in tunnels for example.

A so-called depth imaging camera can also be provided as the recording device, storing the surroundings not only as a two-dimensional image but as a three-dimensional image. This allows a virtual corridor to be established around the train so that objects outside said corridor can be masked out. Depth imaging information filtered in this manner can then be further processed either as three-dimensional or two-dimensional data.

The recordings (images, film, image or film sequences) are transmitted for example to a central unit (e.g. a surveillance and archiving center). Transmission can take place for example wirelessly or by way of a radio interface, in particular by way of a mobile (tele)communication interface (e.g. 2G, 3G, LTE, etc.) as the rail vehicle travels or at predefined time points (e.g. at a stop or intermediate stop). Alternatively or additionally transmission can also be performed in a wired manner or using (preferably removable) storage media (memory cards, hard drives, etc.). In particular different resolutions can be transmitted in different ways. For example low-resolution image material can be transmitted to the central unit by way of a mobile radio interface as the rail vehicle travels and high-resolution image material can be stored on a local hard drive in the rail vehicle. If it should turn out that the low resolution is not adequate for a certain scene or a higher resolution is required for a segment of the journey for example, this scene can be read from the hard drive and transferred in high resolution to the central unit (by way of a wireless or wired interface).

A manual, automatic or at least automated analysis of the incoming or saved data can be performed in the central unit. Such an analysis can include a check as to whether the image data obtained is “normal”, in other words moves within the boundaries of the usual, or whether for example a theft has been carried out, damage is present and/or an offense is being perpetrated or is imminent.

In the latter instance an alarm can be triggered and the police or other services can be sent to the track segment in question.

Reference recordings can be taken along the railroad track and stored using the recording device based on (at least) one training run (also referred to as a measuring run). These reference recordings can be an indication of what is “normal”. It can therefore be determined based on an automated analysis whether the incoming data from a current journey of a rail vehicle corresponds or is sufficiently similar to the reference recordings. If so, there is no suspicion of an offense, theft or vandalism, in other words the image data obtained is “normal”, as described above.

A computer for example can be provided (in the rail vehicle and/or in the central unit), being used to determine whether recordings currently being taken from a rail vehicle correspond to the reference recordings (or are sufficiently similar thereto). Deviations from the reference recordings can be weighted in an automated manner; for example suitable algorithms can be used to determine a measure of similarity, which indicates the probability with which the current recordings correspond to the reference recordings. The resulting probability can be compared for example with a threshold value; if it is below the threshold value a deviation can automatically be identified and if required a predefined action can be initiated in an automated manner. For example as a consequence of the identified deviation a thorough check or a repeat check can be performed with recordings from a rail vehicle passing through said track segment later. Hidden Markov models and corresponding algorithms for example can be used for this purpose.

FIG. 1 shows an exemplary scenario with a rail vehicle 101, moving in the travel direction 102 along a railroad track. The rail vehicle 101 has a computer 103 (e.g. an OBU, a control device, etc.), which receives data from for example recording units 105, 106, 108 and/or 109. The recording units 105, 106, 108, 109 can be arranged at any locations on the rail vehicle 101 and are aligned with the railroad track or the surroundings of the railroad track to the front, rear or side.

The recording units 105, 106, 108, 109 can be embodied as movable, for example the alignment of the recording unit 105, 106, 108, 109 can be changed by way of the computer 103. It is also possible additionally or alternatively for further parameters of the recording units 105, 106, 108, 109 to be settable, e.g. maximum resolution, number of images recorded per unit of time, brightness, selectable optical system, infrared mode, etc.

The computer 103 can edit such recordings, for example creating scenes and/or determining feature vectors based on the recordings or scenes and comparing them with previously recorded scenes and/or feature vectors. To this end the computer 103 can access a database 104 locally, store recordings or feature vectors there or read out data present there for comparison. The rail vehicle 101 also has at least one position determination option (not shown in FIG. 1) so a (relative or absolute) position can also be determined using the recordings taken.

The rail vehicle 101 has a communication interface 107, for example in the form of a radio module or mobile communication facility, allowing a connection to be established to a wireless network 110 by way of a radio interface 111. Such a connection can also exist by way of a wireless or wired interface 112 with a central unit 113 (e.g. a computer, a group of computers or a computer network) so that data can be exchanged between the central unit 113 and the rail vehicle 101. The central unit 113 can be embodied in a distributed or centralized manner and can have a plurality of computers and/or data storage units. A database 114 is shown here by way of example, which can be accessed from the central unit. The database 114 stores for example the feature vectors of training runs in the form of a table or database or in the form of a track map.

The central unit 113 can also supply surveillance monitors 115 for manual processing or assessment of the transmitted recordings.

FIG. 2 shows an exemplary schematic flow diagram showing steps of the method set out here for surveillance of a railroad track. In a step 201 the recording unit takes at least one recording of the railroad track or along the railroad track. In a step 202 the recording is stored locally in the rail vehicle and/or in a central unit. Automated surveillance of the railroad track can be performed efficiently based on the recordings stored in this manner.

In an optional step 203 the recording is analyzed for a predefined incident. This is achieved for example by image recognition mechanisms. This analysis can take place in real time, almost in real time or some time after the actual storing of the recording. In particular it is possible, after an incident has become known, to examine stored (archived) recordings for said incident.

If the predefined incident is identified, a predefined action can be performed in a step 204.

FIG. 3 shows an exemplary schematic flow diagram of a training session (e.g. as performed in the context of a training run of a rail vehicle to create training data, in particular feature vectors).

In a step 301 an individual image or image sequence (film) is recorded during the training run. In a step 302 feature extraction is performed on the recording, producing at least one feature vector. In a step 303 the at least one feature vector is stored or an adaptation is performed on at least one feature vector already present. Storage can be in a database or in a track map.

As indicated, it is possible for a comparison with the reference recordings or preprocessing (filtering) to be performed both on the computer or a control unit of the rail vehicle and in the central unit. Combinations of the allocation of the processing tasks are also possible. For example it could be ensured by preprocessing that only image material with a certain minimum deviation from the reference recordings is evaluated as critical. Such image material, which is classed as critical, can be analyzed or evaluated manually or automatically (with additional higher resolution recordings as required). This can also take place either in the rail vehicle, in other words in situ, or in the central unit.

Suitable preprocessing means that for example only critical events are made known to the central unit or displayed. These critical events can then be further analyzed by the central unit. For example the central unit can specifically instruct a subsequent rail vehicle to supply further recordings, optionally with a higher resolution or at a higher image speed (using a high-speed camera if required) of the point in question. It can then be decided—manually or automatically—based on such further recordings whether a predefined action should be initiated.

Preprocessing reduces the load on the transmission means provided (much less bandwidth is required than if all the data were to be transmitted for example by way of a telecommunication network, even with reduced quality or resolution) as well as the computation capacity required at the central unit.

Progressive compression methods (e.g. JPEG 2000, MPEG-4, H-264) in particular can be used. For example the recordings can be taken with a minimum resolution and additional quality levels can be provided for the respective recording in individual layers. If a recording is classed as critical, said recording can be further analyzed with a higher resolution or quality level. This has the advantage that the processing of image data with the minimum resolution requires much less computation outlay than would be necessary for processing the image data with full resolution.

It is also an option to improve a reference recording (e.g. for a predefined time period or for a scene) adaptively. It can thus be within the range of the normal for a reference recording if the ambient conditions change significantly for example as a function of time, season or other factors. For example deer could always graze by the railroad track between 18:00 and 20:00 hours. Such a variation could be taken into account by means of an adaptation in the reference recordings, for example by storing a number of “normal” recordings, as a function of season or time as required, as reference recordings. A plurality of adaptations are possible, which all take into account “normal” states even if the recordings used may show clear differences.

It is advantageous in particular if maintenance crews next to the railroad track can be distinguished from possible offenders. This can be done in an automated manner, by taking into account further data, for example work schedules which are known to the infrastructure operator and are available there. The location and time of such maintenance crews are known; maintenance crews can also be recognized (automatically) as required based on recordings.

In one variant already recorded and archived recordings are analyzed at a later stage in order for example to identify the perpetrators of a theft or act of vandalism. Recordings of perpetrators can be used for police investigations for example.

The railroad track can be divided into logical sectors for example so that recording devices overlap (slightly) and cover the sectors between two consecutive rail vehicles. The central unit can control the switching of the recording devices so that the most favorable or extensive or continuous surveillance of the sectors possible results as a function of the distances between and speeds of the trains, the ambient situation of the landscape (wood, mountain, tunnel, etc.) as well as the quality of the recordings supplied by the recording devices and the resulting ranges.

One further option is to provide additional recording devices along the railroad track, for example at the side of the railroad track, in curving and/or hilly terrain and before tunnels and to integrate these in the surveillance system.

The known train position can be used to ensure that the recordings always show predefined, in particular identical, image segments. Such recordings can be used as the basis for decisions when investigating offenses or when dealing with scheduling or catastrophes. It means there is no need to inspect the railroad track locally to obtain an image of the surroundings.

With the present approach it is possible to define and observe image segments (image blocks) for traveling trains. Therefore a number of recording devices on a rail vehicle can be controlled in such a manner that a region around the rail vehicle is recorded sequentially by a number of cameras. This produces an image block which can be shown as an individual recording or an image sequence as required. Images or image sequences can be created as reference recordings and supplied for comparison based on such a control system.

Changes in the recorded surroundings can also be taken into account by adapting the reference recordings using the recordings.

When analyzing the recordings known patterns, recordings, schedule data, etc. can be taken into account in order to image different situations correctly. For example animals next to the railroad track, maintenance crews, fallen trees, etc. can be correctly identified and classified in this manner.

The analysis of the recordings can take place automatically using suitable algorithms. For example an image or pattern analysis can be performed in the video data for the analysis and/or a situation description (e.g. “maintenance crew in action on track segment x at kilometer y”) can be taken into account.

Although the invention has been illustrated and described in detail using the at least one illustrated exemplary embodiment, the invention is not limited thereto and other variations can be derived therefrom by the person skilled in the art without departing from the scope of protection of the invention.

1-26. (canceled)

27. A method for surveillance of a railroad track, the method comprising the following steps:
placing a recording unit in or on a rail vehicle;
taking at least one recording of the railroad track or along the railroad track using the recording unit; and
storing the at least one recording in at least one of the rail vehicle or a central unit.

28. The method according to claim 27, which further comprises analyzing the at least one recording for a predefined incident.

29. The method according to claim 28, which further comprises analyzing the at least one recording shortly after storing or after the incident has been detected.

30. The method according to claim 28, which further comprises performing a predefined action when the predefined incident is identified.

31. The method according to claim 30, which further comprises including at least one of the following steps in the predefined action:
assessing a recording or scene by personnel observing surveillance monitors;
identifying people involved in the incident;
making an emergency call;
initiating a police investigation;
forwarding the at least one recording for further analysis; or
forwarding the at least one recording to the central unit.

32. The method according to claim 31, which further comprises:
carrying out the step of identifying people involved in the incident by facial recognition or license plate recognition of vehicles involved;
carrying out the step of making an emergency call by informing at least one of the police, a security service or an emergency service; and
carrying out the step of forwarding the at least one recording with a higher quality level than before.

33. The method according to claim 27, which further comprises including one of the following acts in the incident:
a theft;
an act of damage;
an accident; or
an emergency incident.

34. The method according to claim 27, which further comprises storing the at least one recording with at least one of time information or position information.

35. The method according to claim 27, which further comprises placing a plurality of recording units in or on the rail vehicle.

36. The method according to claim 27, which further comprises placing the recording unit on the front, on the rear or on a side of the rail vehicle.

37. The method according to claim 27, which further comprises including at least one of the following components in the recording unit:
a photographic camera;
a film camera;
an infrared camera;
a depth imaging camera;
a microphone;
a radar device; or
a sensor for determining a relative traveled distance.

38. The method according to claim 27, which further comprises providing the recording unit with a wide-angle lens.

39. The method according to claim 27, which further comprises providing the recording unit with a fish-eye lens.

40. The method according to claim 27, which further comprises transforming the at least one recording.

41. The method according to claim 27, which further comprises transmitting the at least one recording from the rail vehicle to the central unit by using at least one of a wireless interface, a wired interface or a storage medium.

42. The method according to claim 27, which further comprises storing the at least one recording by using a progressive compression algorithm in the rail vehicle and providing different quality levels of a progressively encoded recording for transmission to the central unit.

43. The method according to claim 27, which further comprises analyzing the at least one recording for a predefined incident by comparing the at least one recording with previously stored data.

44. The method according to claim 43, which further comprises identifying the incident if the at least one recording deviates from previously stored data.

45. The method according to claim 43, which further comprises identifying the incident if the at least one recording does not deviate from previously stored data.

46. The method according to claim 43, which further comprises generating the previously stored data by using at least one training run.

47. The method according to claim 46, which further comprises:
taking recordings during the training run; and
editing and storing the recordings.

48. The method according to claim 47, which further comprises editing the recordings by determining at least one feature vector for predefined components or facilities along the railroad track and storing the at least one feature vector.

49. The method according to claim 43, which further comprises performing a plurality of training runs and at least one of averaging or adapting the previously stored data by using the training runs.

50. The method according to claim 27, which further comprises prompting the recording unit by using the central unit to take a recording of the railroad track or along the railroad track in defined positions.

51. A rail vehicle, comprising:
at least one recording unit disposed in or on the rail vehicle; and
at least one processing unit configured to:
take at least one recording of the railroad track or along the railroad track using said recording unit, and
store said at least one recording in at least one of the rail vehicle or a central unit.

52. An apparatus for surveillance of a railroad track, the apparatus comprising:
at least one processing unit configured to:
receive at least one recording of the railroad track or along the railroad track from a recording unit disposed in or on the rail vehicle, and
store the at least one recording.

53. The apparatus according to claim 52, which further comprises:
at least one surveillance monitor on which the at least one recording received from the rail vehicle can be shown,
said at least one surveillance monitor configured to be used for continuous surveillance by personnel.

54. A system, comprising:
a central unit for surveillance of a railroad track; and
at least one rail vehicle including at least one recording unit disposed in or on said rail vehicle and at least one processing unit configured to take at least one recording of a railroad track or along a railroad track using said at least one recording unit and to store said at least one recording in at least one of said rail vehicle or said central unit, said at least one rail vehicle transmitting said at least one recording to said central unit with a predefined quality level;
said central unit including at least one processing unit configured to receive said at least one recording of the railroad track or along the railroad track from said at least one recording unit and to store said at least one recording, said central unit performing a predefined action in the event of a predefined incident based on said recordings and an analysis relating to the predefined incident.
